(19) United States
(12) Patent Application Publication
(10) Pub. No.: US 2020/0127816 A1
(43) Pub. Date: Apr. 23, 2020

(54) VOICE ENCRYPTION DEVICE AND SYSTEM FOR SECURING VOICE COMMUNICATION

(71) Applicant: mKrypt, Inc., Sunnyvale, CA (US)

(72) Inventors: Todd Alan Carper, Sunnyvale, CA (US); Hampton Miller, Corvallis, OR (US)

(21) Appl. No.: 16/655,680

(22) Filed: Oct. 17, 2019

Related U.S. Application Data
(60) Provisional application No. 62/747,698, filed on Oct. 19, 2018.

(51) Int. Cl. H04L 9/06; G10L 15/22; H04K 1/00

(52) U.S. Cl. CPC H04L 9/0656; H04K 1/00; G10L 15/22

(57) ABSTRACT

A voice encryption device including a pseudorandom number generator that generates a key data stream responsive to a cryptographic key; a shift register that sequentially stores a sequence of voice data as a block of voice data; a selector that selects pieces of voice data from among the block of voice data stored by the shift register and provides a rearranged block of voice data including the selected pieces of voice data as initial pieces of voice data in the rearranged block of voice data, responsive to a key data value from among the key data stream; and a combiner that combines the rearranged block of voice data provided from the selector with the block of voice data to generate an encrypted block of voice data.

### BACKGROUND

The present disclosure relates to voice encryption devices and methods for securing voice communication, and more particularly to voice encryption devices and methods for securing voice communication of cellular phones.

Voice communication is typically easy to intercept. For example, voice communication over standard land-lines (e.g., plain old telephone service (POTS)) can be intercepted by clipping onto the wires or path of wires between two callers. Voice communication over cordless phones can be intercepted by using radio frequency scanners. Also, voice communication over early generation cell phones was capable of being intercepted by using radio frequency scanners. Cell phones have however evolved to provide some encryption of voice communication transmitted between the cell phones and the cell service provider. Voice over internet protocol (VOIP) systems have been developed that enable voice communication over the internet, and various approaches have been developed to encrypt the voice communication transmitted over VOIP systems.

In the case of cell phone encryption, algorithms, equipment and methods of attack are known and readily available which enable interception and decryption of voice communication. Additionally, there is no standard encryption method to protect voice communication between cellular service providers. Meaning, that while the voice communication between the cell phone and the service provider may be encrypted, the cellular service provider of the calling party forwards a decrypted version of the voice communication in real-time across an SS7 (Signaling System No. 7) network to the cellular service provider of the called party, thus exposing the voice communication when transported across the SS7 network.

Although VOIP systems initially may have provided improved voice communication security as compared to regular cellular networks, due to poor implementation over time the encryption provided by the VOIP systems has been broken. Additionally, VOIP systems operate only on computers or smart phones, making VOIP applications vulnerable to viruses and trojans that can intercept voice communication before it has been encrypted.

At present, the best commercial attempts at securing voice communication leave the voice communication unprotected when moving between cellular networks and vulnerable to viruses and trojans at each device. Although military and government applications may include special equipment to secure voice communication, the equipment is bulky and difficult to utilize.

### SUMMARY

Embodiments of the inventive concepts provide a voice encryption device including a pseudorandom number generator configured to generate a key data stream responsive to a cryptographic key; a shift register configured to sequentially store a sequence of voice data as a block of voice data; a selector configured to select pieces of voice data from among the block of voice data stored by the shift register and provide a rearranged block of voice data including the selected pieces of voice data as initial pieces of voice data in the rearranged block of voice data responsive to a key data value from among the key data stream; and a combiner configured to combine the rearranged block of voice data provided from the selector with the block of voice data to generate an encrypted block of voice data.

Embodiments of the inventive concepts further provide a voice encryption device including a pseudorandom number generator configured to generate a key data stream responsive to a cryptographic key; a shift register configured to sequentially store a sequence of voice data as a block of voice data; a selector configured to select pieces of voice data from among the block of voice data stored by the shift register and provide a rearranged block of voice data including the selected pieces of voice data as initial pieces of voice data in the rearranged block of voice data responsive to a key data value from among the key data stream; and a combiner configured to combine the rearranged block of voice data provided from the selector with a previous block of voice data received prior to the block of voice data to generate an encrypted block of voice data.

Embodiments of the inventive concepts still further provide a method of securing voice communication between first and second cellular phones using a first voice encryption device paired with the first cellular phone. The method includes determining by the first voice encryption device whether a call has been initiated by the first cellular phone to the second cellular phone; sending by the first cellular phone first identifier tones to the second cellular phone via a network responsive to the first voice encryption device, upon determination that the call has been initiated by the first cellular phone, the first identifier tones indicative that the first cellular phone is paired with the first voice encryption device; determining by the first voice encryption device whether second identifier tones have been received by the first cellular phone from the second cellular phone via the network responsive to the sending the first identifier tones, the second identifier tones indicative that a second voice encryption device is paired with the second cellular phone; setting by the first and second voice encryption devices a secure cryptographic key, upon determining that the second identifier tones have been received; encrypting by the first voice encryption device first voice data using the secure cryptographic key to provide encrypted first voice data; encrypting by the second voice encryption device second voice data using the secure cryptographic key to provide encrypted second voice data; and communicating by the first and second cellular phones the encrypted first and second voice data respectively to the second and first cellular phones via the network.

### BRIEF DESCRIPTION OF THE DRAWINGS

Embodiments of the inventive concepts will be more clearly understood from the following detailed description taken in conjunction with the accompanying drawings in which:

FIG. 1 illustrates a block diagram of a system providing secure voice communication, according to an embodiment of the inventive concepts;

FIG. 2 illustrates a perspective view of the voice encryption device shown in FIG. 1, according to an embodiment of the inventive concepts;

FIG. 3A illustrates a block diagram of the voice encryption device of FIG. 1, according to an embodiment of the inventive concepts;

FIG. 3B illustrates an example of a block of voice data stored and output from shift register 350 of FIG. 3A, according to an embodiment of the inventive concepts;

FIG. 3C illustrates an example of a rearranged block of voice data as rearranged by selector 340 of FIG. 3A, according to an embodiment of the inventive concepts;

FIG. 3D illustrates an example of encrypted voice data generated by combiner 320 of FIG. 3A, according to an embodiment of the inventive concepts;

FIG. 3E illustrates a block diagram of the voice encryption device of FIG. 3A configured for decryption, according to an embodiment of the inventive concepts;

FIG. 4 illustrates a cross-sectional view of the voice encryption device including device housing shown in FIG. 2, according to an embodiment of the inventive concepts;

FIG. 5 illustrates a block diagram of an implementation of the voice encryption device Of FIG. 3, according to an embodiment of the inventive concepts;

FIG. 6 illustrates a flow chart descriptive of operation of a system that secures voice communication, according to embodiments of the inventive concepts;

FIG. 7 illustrates a perspective view of the voice encryption device, according to another embodiment of the inventive concepts;

FIG. 8 illustrates a block diagram of a cellular phone having a built-in voice encryption device capable of securing voice communications, according to another embodiment of the inventive concepts;

FIG. 9 illustrates a perspective view of a cellular phone having an encryption device capable of securing voice communications incorporated into a battery pack, according to another embodiment of the inventive concepts;

FIG. 10 illustrates a depiction of a laptop having a built-in voice encryption device capable of securing voice communications, according to another embodiment of the inventive concepts; and

FIG. 11 illustrates a depiction of a headset having a built-in voice encryption device capable of securing voice communications, according to another embodiment of the inventive concepts.

### DETAILED DESCRIPTION OF THE EMBODIMENTS

Embodiments of the inventive concepts will be described as follows in detail with reference to accompanying drawings.

As is traditional in the field of the inventive concepts, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the inventive concepts. Likewise, the blocks of the embodiments may be physically combined into more complex blocks without departing from the scope of the inventive concepts.

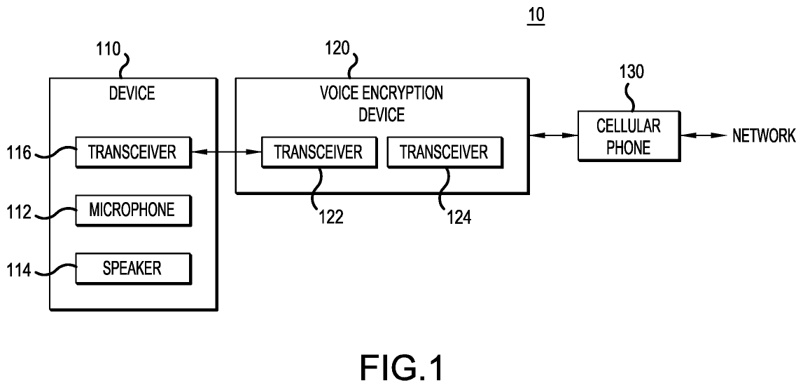

FIG. 1 illustrates a block diagram of a system 10 providing secure voice communication, according to an embodiment of the inventive concepts. System 10 includes device 110, voice encryption device 120 and cellular phone 130.

Device 110 as shown in FIG. 1 includes microphone 112, speaker 114, and transceiver 116, and wirelessly communicates with voice encryption device 120 using short-link transmission. Device 110 wirelessly transmits voice data generated by microphone 112 responsive to the voice of a user to voice encryption device 120 using transceiver 116, and outputs an audible voice to the user via speaker 114 responsive to voice data received by transceiver 116 from voice encryption device 120. Device 110 may be a headset or any type of device including a microphone and a speaker that is capable of wirelessly communicating with voice encryption device 120. Device 110 may or may not be wearable.

Voice encryption device 120 wirelessly communicates with device 110 and cellular phone 130 using short-link transmission. Voice encryption device 120 wirelessly receives the voice data from device 110 using transceiver 122, encrypts the voice data, and wirelessly transmits the encrypted voice data to cellular phone 130 using transceiver 124. Voice encryption device 120 also wirelessly receives encrypted voice data from cellular phone 130 using transceiver 124, decrypts the encrypted voice data, and transmits the decrypted voice data to device 110 using transceiver 122. Voice encryption device 120 includes various circuitry (not shown) other than transceivers 122 and 124, as will be subsequently described.

Cellular phone 130 wirelessly transmits the encrypted voice data provided from voice encryption device 120 to a called cellular phone (not shown) via a network, and also wirelessly transmits encrypted voice data received from the called cellular phone via the network to voice encryption device 120. The short-link transmission may be for example wireless transmission such as Bluetooth, Zigbee, ultrasound, or the like. The network may be a cellular network or a voice over internet protocol (VOIP) network. As will be subsequently described, voice encryption device 120 may be configured to operate in a pass-through mode in which voice data is not modified (e.g., encrypted or decrypted) in any way, and is merely passed between device 110 and cellular phone 130.

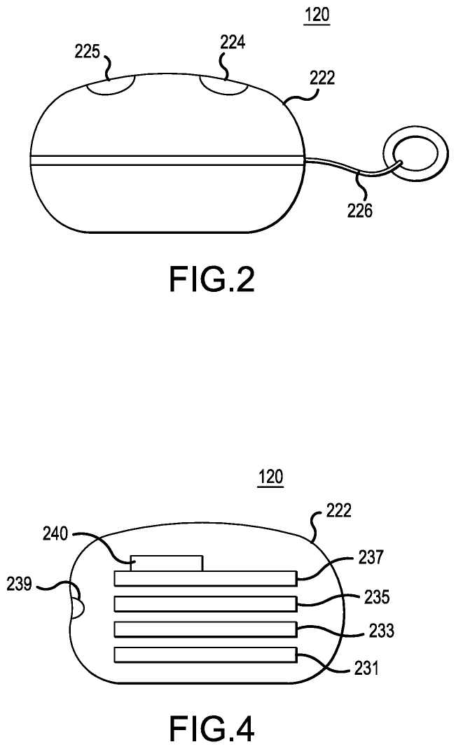

FIG. 2 illustrates a perspective view of voice encryption device 120 shown in FIG. 1, according to an embodiment of the inventive concepts. As shown in FIG. 2, voice encryption device 120 is encapsulated within device housing 222. Device housing 222 may be for example a material such as resin, plastic, and/or other composite materials that do not greatly interfere with radio frequency (RF) transmission and reception. Device housing 222 encapsulates transceivers 122 and 124 (see FIG. 1) in addition to various circuitry (which will be subsequently described) which may disposed on a printed circuit board. Device housing 222 may be waterproof. Actuator 224 disposed in device housing 222 may activate voice encryption device 120 responsive to actuation by a user. Actuator 224 may be a button that activates voice encryption device 120 when depressed by a user. In other embodiments, actuator 224 may be any component that provides input responsive to user manipulation. Voice encryption device 120 may further include validation device 225 which may be a biometric device such as a fingerprint sensor or a camera for example, or an input pad or device for user entry of a personal identification number (i.e., a pin). Subsequent to actuation of actuator 224 by a user, voice encryption device 120 may be configured to require the user to validate his or her identity using validation device 225 prior to full activation. Actuator 224 and validation device 225 may be disposed in various positions on the device housing 222 and are not limited to the positions shown in FIG. 2. Device housing 222 encapsulating voice encryption device 120 may be of compact size, configured to be easily handled and to fit inside a clothing pocket of a user for example, and is shown for the purpose of perspective as connected to a key chain 226.

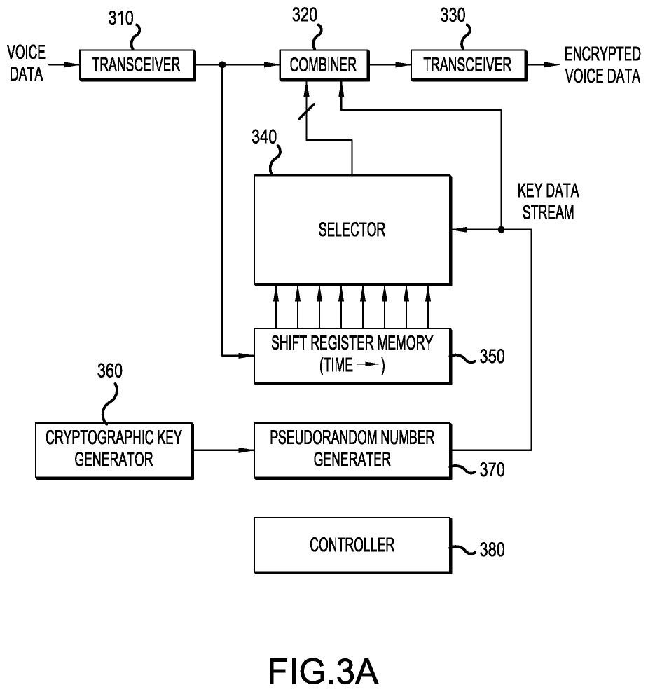

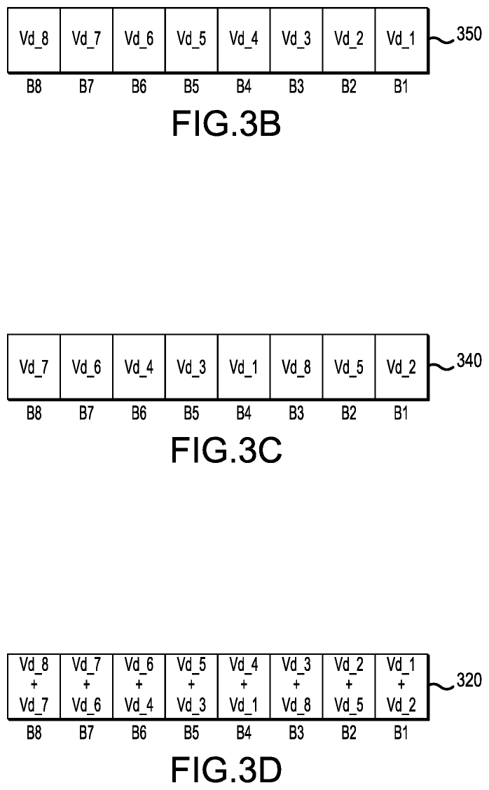

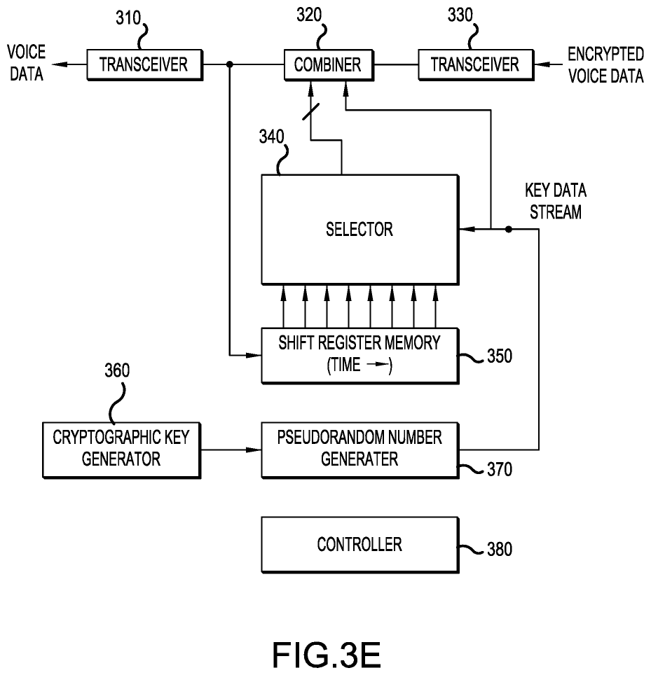

FIG. 3A illustrates a block diagram of voice encryption device 120 of FIG. 1, according to an embodiment of the inventive concepts. Voice encryption device 120 includes transceiver 310, combiner 320, transceiver 330, selector 340, shift register memory 350 (which may hereinafter be referred to as “register”), cryptographic key generator 360, pseudorandom number generator 370 and controller 380.

The following description will be made assuming that device 110 including microphone 112 and speaker 114 is a wearable device such as a headset that is enabled for short-link transmission, and that the user of the headset has initiated a phone call via cellular phone 130 and has spoken into microphone 112. Transceiver 310 (which corresponds to transceiver 122 described with respect to FIG. 1) wirelessly receives voice data from device 110 and under control of controller 380 provides a sequence of voice data to shift register 350. Under control of controller 380, shift register 350 stores received pieces of the voice data in sequential order as indicated by “(time→)”, and outputs the stored pieces of voice data in parallel as a block of voice data to selector 340.

For example, in an embodiment of the inventive concepts, the block of voice data output to selector 340 may include 8 pieces of voice data (or in other words 8 bands). For example, as shown in FIG. 3B, the block of voice data stored and then output from shift register 350 includes 8 pieces of voice data Vd_1, Vd_2, Vd_3, Vd_4, Vd_5, Vd_6, Vd_7 and Vd_8 sequentially shifted into and respectively stored in buckets B1, B2, B3, B4, B5, B6, B7 and B8 of shift register 350. That is, a received first piece of voice data Vd_1 is shifted through shift register 350 and stored in bucket B1, a received second piece of voice data Vd_2 is shifted through shift register 350 and stored in bucket B2, and so on, so that a received eighth piece of voice data Vd_8 of the block of voice data is stored in bucket B8. Each of the pieces of voice data Vd_m may for example represent amplitude of the voice spoken into microphone 112 shown in FIG. 1. The number of pieces of voice data in the block of voice data is not limited to 8 pieces or bands as described, and in other embodiments shift register 350 may include any number of buckets and the block of voice data may include any number of pieces of voice data.

Under control of controller 380, cryptographic key generator 360 generates and outputs a cryptographic key to pseudorandom number generator 370. Although not shown, cryptographic key generator 360 may include a memory that stores a key or user installed keys that define which encryption domains of various encryption domains are supported by voice encryption device 120. Primary domain level keys may be installed into the memory of cryptographic key generator 360 “over-the-air” via a transport mechanism (not shown) such as BLE (Bluetooth low energy), WIFI, or other wireless protocols. Cryptographic key generator 360 may be configured to support installation of the keys via the transport medium. Cryptographic key generator 360 may validate the authenticity of the received key using common cryptographic methods such as for example verification of a digital signature or hash. Cryptographic key generator 360 may be configured to enable user selection of installed keys for a particular call by use of an application running on a desktop or mobile device that communicates with cryptographic key generator 360 via a wireless protocol. The key may also be selected by moving voice encryption device 120 in a specific direction or pattern that switches the device between various keys whereby the result of the change may be confirmed through a flashing light (not shown) on voice encryption device 120 or a display (not shown) on voice encryption device 120 that may indicate the name or identification of the selected key.

Pseudorandom number generator 370 optionally generates a key data stream responsive to the cryptographic key output by cryptographic key generator 360. The key data stream is output to selector 340 and combiner 320. Pseudorandom number generator 370 may utilize a common encryption algorithm such as the American encryption standard (AES), although other algorithms may be used. Pseudorandom number generator 370 generates the key data stream on the basis of the cryptographic key selected and output by cryptographic key generator 360.

In particular, voice encryption device 120 as paired with cellular phone 130 as shown in FIG. 1 must possess and utilize keys from a same encryption domain available to another voice encryption device paired with a called cellular phone to enable communication of encrypted voice data with the called cellular phone. In this case, since a cryptographic key that corresponds to a same encryption domain used by voice encryption device 120 paired with cellular phone 130 is used by a pseudorandom number generator in a voice encryption device paired with the called cellular phone, the key data stream generated by the pseudorandom number generator in the voice encryption device paired with the called cellular phone may be the same as the key data stream generated by pseudorandom number generator 370 paired with cellular phone 130.

Selector 340 is configured to rearrange pieces of voice data in the block of voice data provided from shift register 350 responsive to a key data value from among the key data stream generated by pseudorandom number generator 370, and to output the rearranged pieces of voice data in parallel as a rearranged block of voice data to combiner 320. For example, responsive to a byte or key data value of the key data stream having a first particular value, selector 340 may be configured to select the eighth and first pieces of voice data from among the block of voice data output from shift register 350 respectively as the first two (initial) pieces of voice data of the rearranged block of voice data. As a further example, responsive to a byte or key data value of the key data stream having a second particular value, selector 340 may be configured to select the fourth through seventh pieces of voice data from among the block of voice data output from shift register 350 respectively as the first four (initial) pieces of voice data. As a still further example, responsive to a byte or key data value of the key data stream having a third particular value, selector 340 may be configured to select the second, fifth and eighth pieces of voice data from among the block of voice data output from shift register 350 respectively as the first three (initial) pieces of voice data of the rearranged block of voice data. That is, selector 370 may be configured to select any combination of any number n pieces of voice data from among m pieces of voice data of the block of voice data output from shift register 350 as the initial pieces of voice data of the rearranged block of voice data, responsive to particular key data value. Subsequent to selecting the n pieces of voice data from among the block of voice data responsive to the particular key data value, the remaining (i.e., m−n) pieces of the voice data from among the block of voice data other than the selected pieces of voice data are then sequentially provided in order after the initial pieces of voice data of the rearranged block of voice data, further responsive to the particular key data value. That is, all the pieces of voice data from among the block of voice data corresponding to the sequence of voice data are output in rearranged order as the rearranged block of voice data responsive to a particular key data value, the rearranged block of voice data including in sequential order the selected initial pieces of the voice data followed by the remaining pieces of voice data. In this case, n and m are positive integers, and m>n.

For example, in the case where the byte or key data value of the key data stream is the aforementioned third value so that selector 340 selects the second, fifth and eighth pieces of voice data from among the block of voice data output from shift register 350 respectively as the first three pieces of voice data, the rearranged block of voice data as rearranged by selector 340 would be as illustrated in FIG. 3C.

In some embodiments of the inventive concepts, in addition to rearranging an order or sequence of the voice data in the block of voice data output from shift register 350 to provide the rearranged block of voice data, selector 340 may be further configured responsive to a byte or key data value of the key data stream to invert the amplitude of some of the voice data in the block of voice data output from shift register 350 and/or to change the amplitude of some of the voice data in the block of voice data output from shift register 350. In some embodiments of the inventive concepts, in addition to selector 340 rearranging an order or sequence of the voice data in the block of voice data received from shift register 350 and/or inverting the amplitude of some of the voice data in the block of voice data and/or changing the amplitude of some of the voice data in the block of voice data to provide the rearranged block of voice data, combiner 320 may be configured to insert bands from previous blocks of voice data into empty buckets of the rearranged block of voice data output from selector 340 responsive to a byte or key data value of the key data stream. In this way, pauses or gaps in voice spoken into microphone 112 (see FIG. 1) may be masked so as not be discernable in the encrypted voice data. In embodiments of the inventive concepts, selector 340 may modify the amplitude of up to four pieces of the 8 pieces of voice data from among the block of voice data. That is, the amplitude of only half of the 8 pieces of voice data from among the block of voice data may be modified based on the byte or key data value. Selector 340 may for example consist of FPGAs, ASICs, and/or logic circuits.

Under control of controller 380, in addition to providing the sequence of voice data to shift register 350, transceiver 310 at the same time provides the sequence of voice data to combiner 320. Also under control of controller 380, combiner 320 stores received pieces of the voice data in sequential order in a shift register (not shown) similar to shift register 350, and holds the stored pieces of voice data provided from transceiver 310 as the block of voice data. Combiner 320 is synchronized under control of controller 380 to hold a same corresponding block of voice data as the block of voice data stored and output from shift register 350. That is, under control of controller 380, combiner 320 holds a same block of voice data as the block of voice data that is stored in shift register 350 and that is used to generate the rearranged block of voice data. Combiner 320 may for example include shift registers including buckets B1 through B8 similar to shift register 350 for example. Combiner 320 may then combine the block of voice data held therein with the rearranged block of voice data generated from the corresponding same block of voice data output from shift register 350, to generate and output encrypted voice data to transceiver 330 responsive to a byte or key data value of the key data stream having a particular value. That is, combiner 320 may generate an encrypted block of voice data by combining a block of voice data with a rearranged version of the same block of voice data.

Also, in addition to holding a same block of voice data as the block of voice data that is stored in shift register 350 and that is used to generate the rearranged block of voice data, combiner 320 under control of controller 380 may also hold for example four blocks of voice data received prior to the block of voice data that is stored in shift register 350 and that is used to generate the rearranged block of voice data. Combiner 320 may thus include a plurality of shift registers that cache for example five sequential blocks of voice data. Combiner 320 may combine any one of the four blocks of voice data received prior to the block of voice data that is stored in shift register 350 and that is used to generate the rearranged block of voice data, with the rearranged block of voice data output from selector 340, to generate and output encrypted voice data responsive to a byte or key data value of the key data stream having a particular value. That is, combiner 320 may generate an encrypted block of voice data by combining a rearranged version of a block of voice data with a block of voice data received prior to the block of voice data that is used to generate the rearranged block of voice data. It should be understood that in the case of a first initial block of voice data in the sequence of received voice data, an encrypted block of voice data can be generated by combining the first initial block of voice data with a rearranged version of the same first initial block of voice data and not a previous block of voice data.

FIG. 3D illustrates an example of encrypted voice data generated by combiner 320. Combiner 320 combines a block of voice data held therein (e.g., such as shown in FIG. 3B) with the rearranged block of voice data generated from the same block of voice data (e.g., such as shown in FIG. 3C), responsive to a byte or key data value of the key data stream having a particular value. For example, combiner 320 adds the piece of voice data Vd_1 from the first bucket B1 of the block of voice data (see FIG. 3B) held in the shift register (not shown) of combiner 320 and the piece of voice data Vd_2 from the first bucket B1 of the rearranged block of voice data (see FIG. 3C) as provided from selector 340 to generate the piece of encrypted voice data (Vd_1+Vd_2) in first bucket B1 of the block of encrypted voice data (see FIG. 3D). Combiner 320 adds the piece of voice data Vd_2 from the second bucket B2 of the block of voice data (see FIG. 3B) held in the shift register of combiner 320 and the piece of voice data Vd_5 from the second bucket B2 of the rearranged block of voice data (see FIG. 3C) as provided from selector 340 to generate the piece of encrypted voice data (Vd_2+Vd_5) in second bucket B2 of the block of encrypted voice data (see FIG. 3D). In a similar manner, combiner 320 respectively adds the pieces of voice data from the remaining buckets of the block of voice data held in the shift register of combiner 320 and the pieces of voice data from the remaining buckets of the rearranged block of voice data (see FIG. 3C) as provided from selector 340 to generate pieces of encrypted voice data (Vd_3+Vd_8), (Vd_4+Vd_1), (Vd_5+Vd_3), (Vd_6+Vd_4), (Vd_7+Vd_6) and (Vd_8+Vd_7) in the third through eight buckets B3, B4, B5, B6, B7 and B8 of the block of encrypted voice data (see FIG. 3D).

It should be understood that FIGS. 3B-3D merely show an example embodiment, and that the pieces of voice data may be variously combined depending on the byte or key data value of the key data stream having a particular value. That is, combiner 320 under control of controller 380 may combine any one of the cached blocks of voice data held therein with the rearranged block of voice data output from selector 340.

Transceiver 330 is configured to wirelessly transmit the encrypted voice data to cellular phone 130 shown in FIG. 1. Cellular phone 130 thereafter transmits the encrypted voice data provided from transceiver 330 over the network to the called cellular phone. Combiner 320 may for example consist of shift registers, a ladder of summers and scalers implemented in an FPGA or direct logic circuits, and may hold blocks of voice data and bytes or key data values, combine blocks of voice data and rearranged blocks of voice data, and output blocks of encrypted voice data under control of controller 380.

Controller 380 as shown in FIG. 3A is interconnected with transceiver 310, combiner 320, transceiver 330, selector 340, register 350, cryptographic key generator 360, and pseudorandom number generator 370 through wiring (not shown). Controller 380 is configured to provide control signals and timing signals so that flow of blocks of voice data, the generation of the cryptographic keys and the key data stream, and the operation of selector 340 and combiner 320 are appropriately synchronized. For example, selector 340 and combiner 320 are respectively controlled by controller 380 to perform a single operation responsive to a particular byte or key data value of the key data stream generated by pseudorandom number generator 370. That is, respective bytes or key data values of the key data stream are used to drive each step or operation. No byte or key data value is used for more than one operation related to one block of voice data. For example, a first byte or key data value of the key data stream may determine which four bands of the block of voice data are to be rearranged, while a second byte or key data value of the key data stream may determine which of the bands are to have their amplitude modified, while a third byte or key data value of the key data stream may determine which previous block of voice data is utilized to fill in pauses or gaps in the voice data, and another byte or key data value of the key data stream may determine which previous block of voice data to combine with the rearranged block of voice data output from selector 340. The reference point into the key stream is always moving forward. When the bytes of a key stream are exhausted a new key is generated.

FIG. 3E illustrates a block diagram of voice encryption device 120 of FIG. 3A configured and/or operable for decryption, according to an embodiment of the inventive concepts. In the following description, the device of FIG. 3E is referred to as voice encryption device 120, although it provides functionality of decryption. Since FIG. 3E includes the same components as FIG. 3A and the configuration and functionality of the respective components are substantially the same, description of the components of FIG. 3E that is the same with respect to the description of FIG. 3A may be omitted from the following.

As shown in FIG. 3E, transceiver 330 wirelessly receives encrypted voice data from cellular phone 130 (see FIG. 1) via short-link transmission. The encrypted voice data may be received by cellular phone 130 via the network from another cellular phone paired with a voice encryption device. Under control of controller 380, transceiver 330 provides a sequence of encrypted voice data to combiner 320. Combiner 320 stores received pieces of the encrypted voice data in sequential order in a shift register (not shown) similar to shift register 350, and holds the stored pieces of encrypted voice data as an encrypted block of voice data. Under further control of controller 380, the sequence of encrypted voice data is also provided to shift register 350. At this time, under control of controller 380, transceiver 310 is prevented from receiving the sequence of encrypted voice data provided from combiner 320. Under control of controller 380, shift register 350 stores received pieces of the encrypted voice data in sequential order as indicated by “(time→)”, and outputs the stored pieces of encrypted voice data in parallel as an encrypted block of voice data to selector 340. As an example, both the encrypted block of voice data held in combiner 320 and the encrypted block of voice data output from shift register 350 to selector 340 may be as shown in FIG. 3D.

The bytes or key data values of the key data stream are sequentially provided from pseudorandom number generator 370 to selector 340 and combiner 320. Under control of controller 380, selector 340 first changes the amplitude and/or inverts the amplitude of the encrypted block of voice data output from shift register 350 responsive to the received bytes or key data values of the key data stream. The encrypted block of voice data having changed or inverted amplitude is output from selector 340 to combiner 320. Under control of controller 380, combiner 320 then subtracts the encrypted block of voice data having changed or inverted amplitude from a corresponding decrypted block of voice data held in the aforementioned shift registers of combiner 320 responsive to the received bytes or key data values of the key data stream, to provide an intermediate block of voice data. Thereafter under control of controller 380, combiner 320 rearranges the bands or pieces of voice data of the intermediate block of voice data responsive to the received bytes or key data values of the key data stream to generate a decrypted block of voice data. The decrypted block of voice data is output to transceiver 310. Under control of controller 380, transceiver 310 transmits the decrypted block of voice data as original voice data to transceiver 116 of device 110 (see FIG. 1) via short-link transmission. Shift register 350 is controlled by controller 380 at this time and does not receive the decrypted block of voice data.

For example, under control of controller 380, responsive to a first byte or key data value of the key data stream, combiner 320 rearranges four bands or pieces of voice data of the intermediate block of voice data to generate a decrypted block of voice data. Under control of controller 380, responsive to the following second byte or key data value of the key data stream, selector 340 determines which bands are to have their amplitude modified or adjusted. Under control of controller 380, responsive to the following third byte or key data value of the key data stream, selector 340 adjusts the amplitude of the band selected based on the second byte or key data value. Under control of controller 380, responsive to the fourth byte or key data value of the key data stream, selector 340 adjusts the amplitude of the next selected band of audio data. This process continues until the amplitude of all selected bands are adjusted. The amplitude is adjusted by adding the value of the corresponding byte or key data value to the existing band amplitude.

As described previously, combiner 320 includes plural shift registers, and in the case of voice encryption device 120 being used for decryption, the shift registers maintain a circular queue of previous decrypted blocks of voice data for the specific audio channel, for example 5 to 10 seconds of voice data. Typically, voice encryption device 120 includes two audio channels, although in some embodiments more than two audio channels may be included. One audio channel is for outgoing voice data and the other channel is for incoming voice data. The two channels are managed separately in that the utilization of keys and data stored in the shift registers are specific to the channel.

As the decryption process proceeds, under control of controller 380, responsive to a next following byte or key data value of the key data stream, combiner 320 selects a previous decrypted block of voice data held in the shift registers that maintain the circular queue of previous decrypted blocks of voice data and adds it to the encrypted block of voice data having changed or inverted amplitude as output from selector 340 to provide the intermediate block of voice data. Of note, initially the shift registers in combiner 320 contain no previous decrypted blocks of voice data, but once a first decrypted block of voice data is generated it is cached in the aforementioned shift registers of combiner 320. It should be understood that for the case of a first initial encrypted block of voice data in combiner 230, decryption is performed based on adjusting the amplitude of the bands of the encrypted block of voice data and then rearranging the bands of the encrypted block of voice data based on the value from the key stream.

Accordingly, during the decryption process voice encryption device 120 of FIG. 3E basically reverses the encryption performed by voice encryption device 120 as described with respect to FIG. 3A. Each side has negotiated the encryption domain so that the same key will make the same decision regarding which bands are to be selected and adjusted. Once the first encrypted block of voice data is decrypted, the destination side inserts the decrypted, clear block of voice data into a shift register of combiner 320. The destination is then ready to process the next incoming encrypted block of voice data.

FIG. 4 illustrates a cross-sectional view of voice encryption device 120 including device housing 222 shown in FIG. 2, according to an embodiment of the inventive concepts. Referring to FIG. 4, voice encryption device 120 includes coil 231, charger 233, battery 235 and circuit board 237. Coil 231 is configured to generate an induced current responsive to an externally generated electromagnetic field. Charger 233 is configured to charge battery 235 using the induced current provided by coil 231. Battery 235 provides operating power for voice encryption device 120. Transceiver 310, combiner 320, transceiver 330, selector 340, shift register 350, cryptographic key generator 360, pseudorandom number generator 370 and controller 380 as described with respect to FIGS. 3A and 3E may be disposed on printed circuit board 237.

In some embodiments of the inventive concept, voice encryption device 120 of FIG. 4 may also include port 239 that is configured to be detachably connectable to an external power source via a USB wire for example. Although not shown, port 239 may be internally connected to charger 233 and may provide power from the external power source to the charger 233 for charging battery 235. In some embodiments in which voice encryption device 120 includes port 239, coil 231 may be omitted. It should be understood that actuator 224 and validation device 225 have been omitted from FIG. 4 merely for the purpose of simplifying the drawing, and that actuator 224 and validation device 225 should be considered as also disposed in device housing 222 shown in FIG. 4. Corresponding circuitry of actuator 224 and validation device 225 may also be disposed on circuit board 237.

In some embodiments of the inventive concepts, accelerometer 240 may be disposed on circuit board 237 as shown in FIG. 4. Accelerometer 240 is configured to activate voice encryption device 120 responsive to predefined user initiated movement of device housing 222 which encapsulates voice encryption device 120. The predefined user initiated movement may for example include tapping voice encryption device 120 on a hard surface, or movement of voice encryption device 120 in a single specific motion or in a combination of directions. In some embodiments in which voice encryption device 120 includes accelerometer 240, actuator 224 may be omitted. In some embodiments, an inertial switch may be used instead of accelerometer 240.

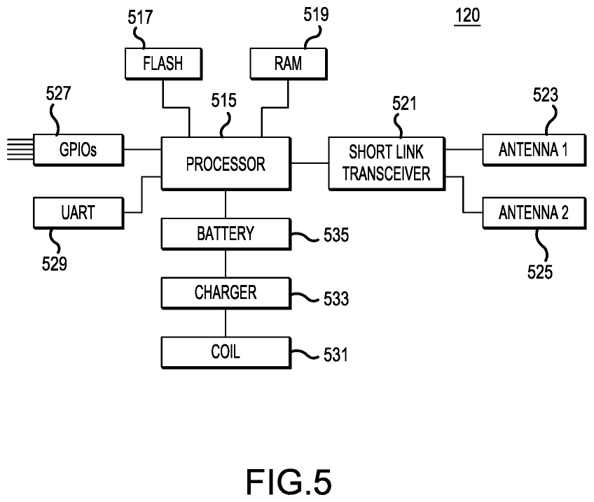

FIG. 5 illustrates a block diagram of an implementation of voice encryption device 120, according to an embodiment of the inventive concepts. Voice encryption device 120 as implemented in FIG. 5 includes processor 515, flash memory 517, random access memory (RAM) 519, short-link transceiver 521, first antenna (antenna¹) 523, second antenna (second antenna²) 525, general-purpose input/output pins (GPIOs) 527, universal asynchronous receiver-transmitter (UART) 529, coil 531, charger 533 and battery 535.

Processor 515 may be a digital signal processor driven by software stored in non-volatile flash memory 517 to carry out the functions or functionality of combiner 320, selector 340, shift register 350, pseudorandom number generator 370, cryptographic key generator 360 and controller 380 described with respect to FIGS. 3A-3E. The software in flash memory 517 may be stored during manufacture of voice encryption device 120 and may also be updated by the user through GPIOs 527. Flash memory 517 may also store cryptographic keys corresponding to various encryption domains supported by voice encryption device 120. The cryptographic keys may be stored in flash memory 517 by the manufacturer or by the user through GPIOs 527. RAM 519 may be used as a working memory and/or as storage for pairing information with a mobile device or headset.

Short-link transceiver 521 as coupled to first antenna 523 may together provide the functionality of transceiver 310 of FIGS. 3A and 3E, and short-link transceiver 521 as coupled to second antenna 525 may together provide the functionality of transceiver 330 of FIGS. 3A and 3E. Coil 531, charger 533 and battery 535 respectively provide the functionality of coil 231, charger 233 and battery 235 described with respect to FIG. 4. As described with respect to FIG. 4, in some embodiments voice encryption device 120 may also include a port (such as port 239 in FIG. 4) that is configured to be detachably connectable to an external power source via a USB wire for example. In some embodiments which include a port (such as port 239 in FIG. 4) that is configured to be detachably connectable to an external power source, coil 531 may be omitted from voice encryption device 120 shown in FIG. 5. In some embodiments voice encryption device 120 as shown in FIG. 5 may include an actuator and a validation device such as actuator 224 and validation device 225 as respectively shown in FIG. 2. GPIOs 527 and UART 529 may for example be used to facilitate key loading, and/or controlling biometric devices for authentication. GPIOs 527 and UART 529 may for example be used to add a display, LEDs, a global positioning system (GPS), cryptographic engines, coprocessors or other desired peripherals to voice encryption device 120. In some embodiments, GPIOs 527 and UART 529 may be omitted.

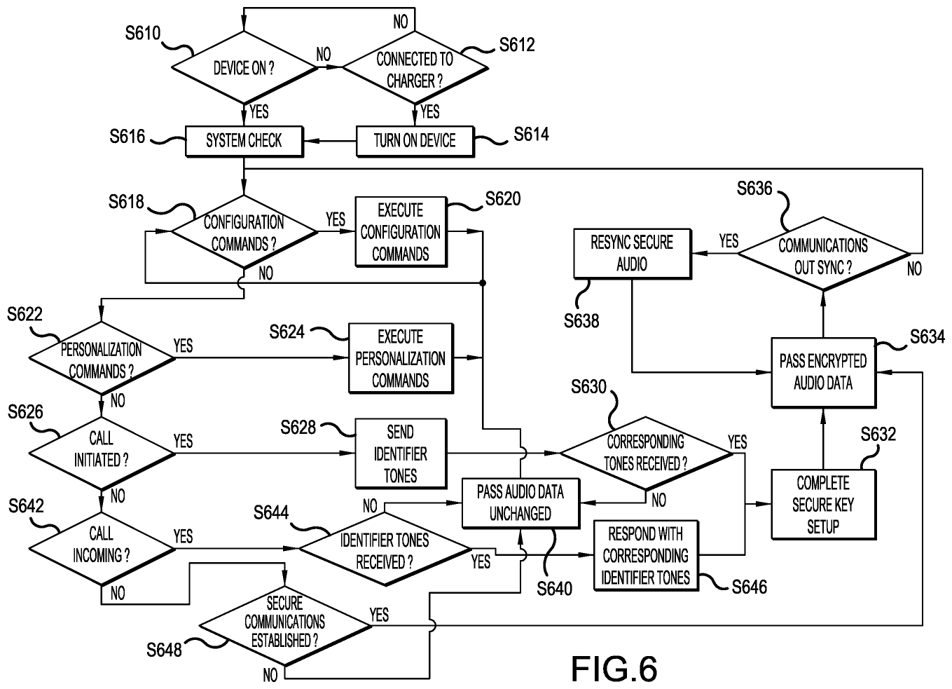

FIG. 6 illustrates a flow chart descriptive of operation of a system that secures voice communication according to embodiments of the inventive concepts. FIG. 6 will hereinafter be described with reference to FIGS. 1-5. It should be understood that the description will be of communication between a first cellular phone such as cellular phone 130 paired with a first voice encryption device such as voice encryption device 120, and a second cellular phone such as cellular phone 130 paired with a second voice encryption device such as voice encryption device 120, over a network such as a cellular network or a VOIP network for example. The first and second voice encryption devices as generally referred to may be voice encryption device 120 as described with respect to any of FIGS. 1-5, although the following description may focus primarily on the implementation shown in FIG. 5 for convenience.

In S610, processor 515 determines whether the first voice encryption device of the first cellular phone is on (i.e., all components as shown in FIG. 5 for example are powered up or activated). The voice encryption device may be turned on responsive to actuator 224, validation device 225, or accelerometer 240. It should be understood that in the off state, all the components of the first and second voice encryption devices may be in a low power (sleep) mode in which processor 515 monitors actuator 224, validation device 225 and/or accelerometer 240.

When the voice encryption device is determined not to be on (No in S610), operation proceeds to S612 and processor 515 determines whether the voice encryption device is connected to an external power supply (e.g., through a port such as port 239) or is being inductively charged.

When the voice encryption device is determined to be connected to an external power supply and/or is being charged (Yes in S612), operation proceeds to S614 and the voice encryption device is turned on.

When the voice encryption device is determined not to be connected to an external power supply and/or is not being charged (No in S612), operation returns to S610. In embodiments, a device may be programmably transitioned into an Off state for purposes of safely shipping or transporting the device, since it may contain a lithium ion battery which necessitates that certain regulations be complied with during transport.

When the voice encryption device is determined to be on (Yes in S610) or is turned on at S614, operation proceeds to S616. In S616 processor 515 performs a system check of the voice encryption device by confirming for example that RAM memory is accessible, key domain information is available, and the transceiver is responsive to commands, and operation thereafter proceeds to S618.

In S618 processor 515 determines if configuration commands have arrived via wireless or other communication methods and are pending to be processed.

When configuration commands are available (Yes in S618), operation proceeds to S620 and processor 515 executes or stores the configuration commands. The configuration commands may include for example the transfer and storage of key domain keys and device serial number. After completion of execution of the configuration commands in S620, operation returns to S618.

When configuration commands are not available, or have already been executed and thus are no longer available, (No in S618), operation proceeds to S622.

In S622 processor 515 determines whether personalization commands are available.

When personalization commands are available (Yes in S622), operation proceeds to S624 and processor 515 executes or stores the personalization commands. The personalization commands may include the user name of a person assigned the device, or other customer specific information. After completion of the personalization commands, operation proceeds to S618.

When personalization commands are not available (No is S622), operation proceeds to S626 and processor 515 determines whether a call has been initiated. The call may be initiated by user command provided through device 110 (see FIG. 1) for example.

When a call has been initiated (Yes in S626), processor 515 controls the paired first cellular phone to send first identifier tones to the second cellular phone via the network. For example, processor 515 may send commands to the paired first cellular phone via short-link transceiver 521 and antenna 525, the commands instructing the paired first cellular phone to send the first identifier tones to second cellular phone via the network. The first identifier tones are indicative that the first cellular phone is paired with the first voice encryption device. Operation then proceeds to S630.

In S630, processor 515 determines whether the paired first cellular phone has received second identifier tones from the second cellular telephone responsive to the sent first identifier tones. Processor 515 may receive from the paired first cellular phone via short-link transceiver 521 and antenna 525 notice that the second identifier tones have been received. The second identifier tones are indicative that the second cellular phone is paired with a second voice encryption device.

When the second identifier tones have been received (Yes in S630), processor 515 consequently confirms that the second cellular phone includes the paired second voice encryption device and is capable of communication of encrypted voice data. Operation then proceeds to S632.

In S632 processor 515 completes a secure cryptographic key setup, so that the cryptographic key generator (e.g., cryptographic key generator 360 in FIG. 3) of the first voice encryption device paired with the first cellular phone may generate a cryptographic key that corresponds to a same encryption domain available for use by the second voice encryption device paired with the second cellular phone. That is, in the secure key setup the first and second voice encryption devices confirm a cryptographic key of a commonly available encryption domain for encrypted communication. The user of the first cellular phone may select an encryption domain from among encryption domains common to the first and second voice encryption devices of the corresponding first and second cellular phones. The first voice encryption device of the first cellular phone may send identification of the selected encryption domain to the second voice encryption device of the second cellular phone over the network. Operation thereafter proceeds to S634.

In S634, processor 515 controls the first encryption device to generate encrypted voice data using the corresponding cryptographic key in a manner such as described with reference to FIG. 3A, and to transmit the encrypted voice data from the first encryption device to the first cellular phone (e.g., cellular phone 130) using the short-link transceiver (e.g., short-link transceiver 330), and the encrypted voice data is then transmitted from the first cellular phone to the second cellular phone over the network. Operation thereafter proceeds to S636.

In S636 processor 515 determines whether encrypted communication between the first cellular phone and the second cellular phone is not synchronized. Due to errors along the network transmission path, it is possible that the encrypted voice data may be corrupted in such a way that it can not be decrypted. When the received encrypted voice data can not be properly decrypted, a synchronization process must thereafter be initiated to re-establish secure communication.

When it is determined that encrypted communication is out of synchronization (Yes in S636), operation proceeds to S638. In S638 processor 515 completes a secure cryptographic key setup such as described with respect S632. Thereafter operation proceeds to S634. When it is determined that encrypted communication is not out of synchronization, operation returns back to S618.

When the second identifier tones have not been received (No in S630), operation proceeds to S640. When the first voice encryption device paired with the first cellular phone has not received the second identifier tones from the second cellular phone in S630 subsequent to sending the first identifier tones to the second cellular phone in S628, processor 515 of the first voice encryption device determines that the second cellular phone is not paired with a voice encryption device and is not capable of secure encrypted voice communication. Consequently, in S640 processor 515 of the first voice encryption device passes the voice data received from device 110 (see FIG. 1) without encryption to the first cellular phone for transmission to the second cellular phone via the network, and thereafter operation returns to S618.

When a call has not been initiated at the first cellular phone (No in S626), operation proceeds to S642. In S642, processor 515 determines if an incoming call has been received by the first cellular phone.

When an incoming call has been received (Yes in S642) by the first cellular phone (e.g., from the second cellular phone), processor 515 of the first voice encryption device determines in S644 whether identifier tones (which may for example be characterized as the aforementioned second identifier tones received from a second cellular phone for the purpose of maintaining consistent description) have been received via the network. Processor 515 of the first encryption device may receive indication from the first cellular phone upon reception of the second identifier tones. The received second identifier tones indicate that the second cellular phone (the calling phone) is paired with a second encryption device and is capable of encrypted voice communication.

When reception of the second identifier tones is determined (Yes in S644), operation proceeds to S646. In S646, processor 515 of the first encryption device controls the paired first cellular phone to send identifier tones (which may for example be characterized as the aforementioned first identifier tones for the purpose of consistency) to the second cellular phone via the network, as indication that the first cellular phone is paired with the first encryption device and is capable of encrypted voice communication. Operation thereafter proceeds to S632 to complete the secure key setup as previously described.

When reception of the second identifier tones is not determined (No in S644), operation proceeds to S640. Since the second identifier tones have not been received from the second cellular phone, in step S640 processor 515 of the first voice encryption device passes the voice data received from device 110 (see FIG. 1) without encryption to the first cellular phone for transmission to the second cellular phone via the network, and thereafter operation returns to S618.

If the determination in S618, S622, S626, and S642 are all No, operation proceeds to S648 and processor 515 determines if the system is presently engaged in a secure call. If the system is not engaged in a secure call (No in S648), operation proceeds to S640 and voice data is transmitted to the second cellular phone without encryption, and thereafter operation returns to S618. When it is determined in S648 that a secure call is in progress or currently being carried out (Yes in S648), operation proceeds to S634 and encryption or decryption as described with respect to FIGS. 3A and 3E are performed.

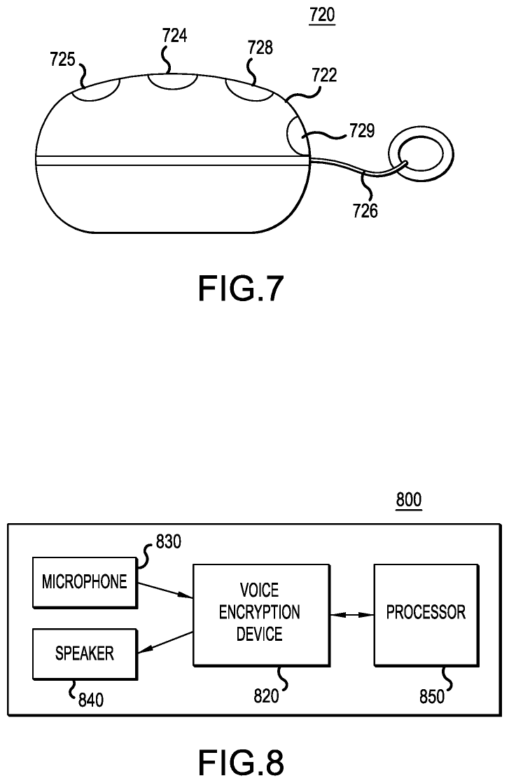

FIG. 7 illustrates a perspective view of voice encryption device 720 according to another embodiment of the inventive concepts. Voice encryption device 720 includes device housing 722, actuator 724 and validation device 725 which are of respectively similar construction and functionality as device housing 222, actuator 224 and validation device 225 as described with respect to FIG. 2. Voice encryption device 720 may also include short-link transceivers such as short-link transceivers 122 and 124 shown in FIG. 1 for respective wireless communication with a device such as device 110 in FIG. 1 and a cellular phone such as cellular phone 130 in FIG. 1. Voice encryption device 720 also includes microphone 728 and speaker 729 disposed in device housing 722. Microphone 728 is configured to generate voice data such as the aforementioned sequence of voice data directly responsive to the voice of the user. That is, the user may speak directly into microphone 728 of voice encryption device 720 to generate encrypted voice data instead of speaking into microphone 112 of device 110. Speaker 729 may output an audible voice to the user. Actuator 724, validation device 725, microphone 728 and speaker 729 may be disposed in various positions on the device housing 722 and are not limited to the positions shown in FIG. 7. Key chain 726 is shown for the purpose of perspective.

FIG. 8 illustrates a block diagram of a cellular phone 800 having a built-in voice encryption device capable of securing voice communications, according to another embodiment of the inventive concepts. As shown in FIG. 8, cellular phone 800 includes among other various features voice encryption device 820, microphone 830, speaker 840 and processor 850. It should be understood that microphone 830, speaker 840 and processor 850 may be existing standard components of the cellular phone 800. Voice encryption device 820 may include circuitry and functionality as described with respect to FIGS. 3A and 3E, including combiner 320, selector 340, shift register 350, cryptographic key generator 360, register 370, and controller 380. However, since voice encryption device 830 is a built-in component of cellular phone 800 and may for example be disposed on a circuit board within cellular phone 800, short-link transceivers 310 and 330 such as shown in FIGS. 3A and 3E are unnecessary and are omitted from cellular phone 800.

In FIG. 8, voice encryption device 820 is hard-wired to microphone 830 to receive voice data generated by microphone 830, and generates encrypted voice data responsive to the voice data in a manner such as described with respect to FIG. 3A. The encrypted voice data may be provided to processor 850 and then transmitted over a network to a called cellular phone paired with another voice encryption device. Voice encryption device 820 may also receive encrypted voice data over a network from a calling cellular phone paired with another voice encryption device. Voice encryption device 820 may decrypt the received encrypted voice data in a manner such as described with respect to FIG. 3E, and send the decrypted voice data to speaker 840. Voice encryption device 820 is hard-wired to speaker 840. Since voice encryption device 820 is built-in cellular phone 800, voice encryption device 820 may be connected to the phone battery and therefore may not include a separate dedicated battery and charger. An existing key pad or a touch screen panel built in cellular phone 800 and a camera built-in cellular phone 800 may respectively function as an actuator such as actuator 224 in FIG. 2 and a validation device such as validation device 225 of FIG. 2.

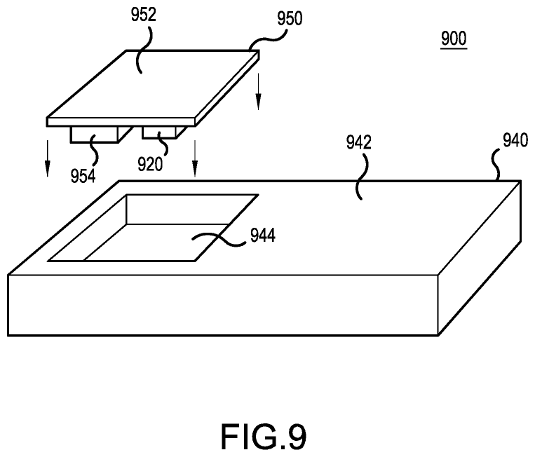

FIG. 9 illustrates a perspective view of cellular phone 900 having voice encryption device 920 capable of securing voice communications incorporated into a battery pack, according to another embodiment of the inventive concepts. As shown in FIG. 9, battery pack 950 including lid 952 is configured to be inserted and secured into space (i.e., compartment) 944 formed in rear surface 942 of phone housing 940. Battery 954 and voice encryption device 920 are disposed on the inner surface of lid 952, and may each include contacts (not shown) providing electrical connection to the components and circuitry within cellular phone 900. Voice encryption device 920 may include a port (not shown) such as GPIOs 527 shown in FIG. 5 for example, that is detachably connectable to cellular phone housing 940, and through which voice encryption device 920 communicates the encrypted voice data with the cellular phone. The port may also receive operating power for voice encryption device 920 from the cellular phone. Voice encryption device 920 may be connected to an existing microphone, speaker and processor (all not shown) of cellular phone 900, and may encrypt and decrypt voice communication in a similar manner as voice encryption device 820 described with reference to FIG. 8.

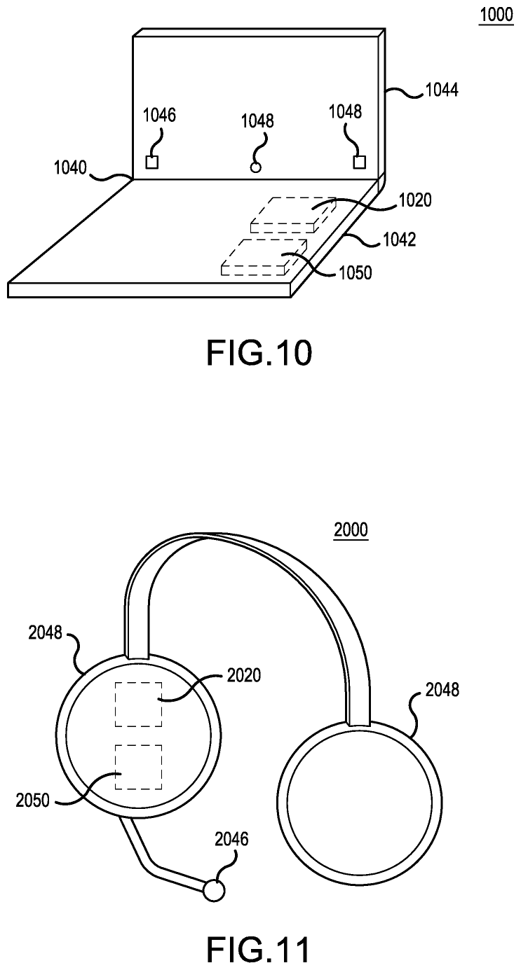

FIG. 10 illustrates a depiction of laptop 1000 having a built-in voice encryption device capable of securing voice communications, according to another embodiment of the inventive concepts. Laptop 1000 may be a portable computer device, and includes housing 1040 with base 1042 and lid 1044. Base 1042 may include voice encryption device 1020 and laptop audio circuitry 1050 that are depicted with dashed lines indicative that the components are disposed within base 1042 on circuit boards for example, and also a keyboard and a mouse pad (not shown). Lid 1044 may include a screen (not shown), microphone 1046 and speaker(s) 1048. Voice encryption device 1020 may be connected to microphone 1046, speaker(s) 1048, processor circuitry (not shown) within laptop 1000 and audio circuitry 1050. Voice encryption device 1020 may receive voice data from microphone 1046, encrypt the voice data in a similar manner as described with reference to FIG. 3A, and provide the encrypted voice data to audio circuitry 1050. Audio circuitry 1050 wirelessly transmits the encrypted voice data provided from voice encryption device 1020 to a cellular phone or another laptop via a cellular network or a VOIP network for example. Audio circuitry 1050 may also wirelessly receive encrypted voice data from a cellular phone or another laptop via a cellular network or a VOIP network for example, and may provide the encrypted voice data to voice encryption device 1020. Voice encryption device 1020 may decrypt the encrypted voice data in a similar manner as described with respect to FIG. 3E, and the decrypted voice data may be played as audio on speaker(s) 1048 under control of the processor circuitry (not shown) of laptop 1000.

In some embodiments, laptop 1000 as described with respect to FIG. 10 may include a built-in short-link transmission component (not shown) that may wirelessly receive voice data from a device such as device 110 of FIG. 1 and that may wirelessly transmit decrypted voice data to a device such as device 110 of FIG. 1. The short-link transmission component may for example communicate via wireless transmission such as Bluetooth, Zigbee, ultrasound, or the like. It should be understood that in other embodiments, voice encryption device 1020, microphone 1046, speaker(s) 1048 and audio circuitry 1050 may be disposed at various locations on or within housing 1040.

FIG. 11 illustrates a depiction of headset 2000 having a built-in voice encryption device capable of securing voice communications, according to another embodiment of the inventive concepts. Headset 2000 includes a pair of speakers 2048 configurable to be disposed over or insertable into a user's ears, and microphone 2046 configured to be positionably adjustable in a vicinity of a user's mouth. Headset 2000 includes voice encryption device 2020 and short-link transmission circuitry 2050 that are depicted with dashed lines indicative that the components are disposed within housing of one of speakers 2048 on circuit boards for example. Voice encryption device 2020 may be connected to microphone 2046, speakers 2048 and short-link transmission circuitry 2050. Voice encryption device 2020 may receive voice data from microphone 2046, encrypt the voice data in a similar manner as described with reference to FIG. 3A, and provide the encrypted voice data to short-link transmission circuitry 2050. Short-link transmission circuitry 2050 may wirelessly transmit the encrypted voice data provided from voice encryption device 2020 to a cellular phone or laptop, which in turn may transmit the encrypted voice data to a called cellular phone or another laptop via a cellular network or a VOIP network for example. Short-link transmission circuitry 2050 may also wirelessly receive encrypted voice data from a cellular phone or a laptop, and may provide the encrypted voice data to voice encryption device 2020. Voice encryption device 2020 may decrypt the encrypted voice data in a similar manner as described with respect to FIG. 3E, and the decrypted voice data may be played as audio on speakers 2048. In some embodiments headset 2000 may include a single speaker 2048 that may be attached to a user's ear. The short-link transmission component may for example communicate via wireless transmission such as Bluetooth, Zigbee, ultrasound, or the like.

Accordingly, in some embodiments of the inventive concepts, the core elements and functionality of the voice encryption device may be integrated directly within existing headsets, speakerphones, car phones, laptops, notebooks, mobile devices and various other portable electronic devices for example, such that a separate device as described with respect to FIG. 2 for example is not necessary.

Additionally, in some embodiments of the inventive concepts, the core elements and functionality of the voice encryption device may be integrated within a device that attaches directly to a mobile device such as for example a battery pack, a camera, or a biometric authentication device for example. The system and functionality may be integrated by wireless communication as previously described or by utilizing a direct wired connection or plugged interface adapter.

In embodiments of the inventive concepts, a first cellular phone paired with a first voice encryption device may communicate encrypted voice data with a second cellular phone paired with a second voice encryption device. In a pass-through mode when both the first and second voice encryption devices do not support a same encryption domain, the first and second cellular phones may communicate non-encrypted voice data.

Existing technology typically utilizes software operating on a computer or mobile device to encrypt voice data. However, a computer or mobile device may be exposed to viruses or trojans that enable unauthorized persons to obtain encryption keys, or to more simply acquire the incoming unencrypted audio from the microphone or from the mobile device when the decrypted audio is sent to the speaker or headset. According to embodiments of the inventive concepts, the encryption and decryption of voice data may be performed separate from the computer or mobile device to prevent an unauthorized person from using a virus or trojan installed in the computer or mobile device from obtaining unencrypted voice data.

As described above, example embodiments have been disclosed in the drawings and specification. While the embodiments have been described herein with reference to specific terms, it should be understood that they have been used only for the purpose of describing technical ideas of the inventive concepts and not for limiting the scope of the inventive concepts. Therefore, those skilled in the art will appreciate that various modifications and equivalent embodiments are possible without departing from the scope of the inventive concepts.

1. A voice encryption device comprising:
a pseudorandom number generator configured to generate a key data stream responsive to a cryptographic key;
a shift register configured to sequentially store a sequence of voice data as a block of voice data;
a selector configured to select pieces of voice data from among the block of voice data stored by the shift register and provide a rearranged block of voice data including the selected pieces of voice data as initial pieces of voice data in the rearranged block of voice data responsive to a key data value from among the key data stream; and
a combiner configured to combine the rearranged block of voice data provided from the selector with the block of voice data to generate an encrypted block of voice data.

2. The voice encryption device of claim 1, wherein the combiner is configured to add pieces of voice data of the rearranged block of voice data to corresponding pieces of voice data of the block of voice data to provide the encrypted block of voice data.

3. The voice encryption device of claim 1, wherein the combiner is further configured to insert voice data of a previous block of voice data into blank spaces of the rearranged block of voice data.

4. The voice encryption device of claim 1, wherein the selector is further configured to invert and/or change amplitude of the pieces of voice data in the block of voice data.

5. The voice encryption device of claim 1, wherein the selected pieces of voice data consist of n pieces of voice data, and the block of voice data consists of m pieces of voice data, wherein n and m are positive integers and m>n.

6. The voice encryption device of claim 1, wherein the rearranged block of voice data includes the selected pieces of voice data as the initial pieces of voice data followed by remaining pieces of voice data from among the block of voice data other than the selected pieces of voice data sequentially in order after the initial pieces of voice data.

7. The voice encryption device of claim 1, wherein the pseudorandom number generator, the shift register, the selector and the combiner are disposed on a printed circuit board,
the voice encryption device further comprising device housing configured to encapsulate the pseudorandom number generator, the shift register, the selector, the combiner and the printed circuit board.

8. The voice encryption device of claim 7, wherein the device housing comprises a port detachably connectable to a cellular phone,
the voice encryption device further configured to communicate the encrypted block of voice data with the cellular phone via the port.

9. The voice encryption device of claim 8, wherein the port is configured to receive operating power for the voice encryption device from the cellular phone.

10. The voice encryption device of claim 7, further comprising a button disposed on the device housing and configured to activate the voice encryption device responsive to actuation by a user.

11. The voice encryption device of claim 1, wherein the pseudorandom number generator, the shift register, the selector and the combiner are disposed on a printed circuit board within a cellular phone, the cellular phone comprising a processor and a microphone, and
the voice encryption device is configured to receive the sequence of voice data from the microphone and to provide the encrypted block of voice data to the processor via wiring.

12. The voice encryption device of claim 11, wherein the voice encryption device is configured to receive power from a battery of the cellular phone.

13. The voice encryption device of claim 1, further comprising:
a first transceiver configured to wirelessly communicate with a device including a microphone and a speaker, and to generate the sequence of voice data responsive to detection of voice data received from the device including the microphone and the speaker by the first transceiver; and
a second transceiver configured to wirelessly communicate the encrypted block of voice data with a cellular phone.

14. The voice encryption device of claim 13, wherein the first transceiver and the second transceiver are respectively configured to wirelessly communicate with the device including the microphone and the speaker and with the cellular phone via short-link transmission.

15. The voice encryption device of claim 1, further comprising a battery, the voice encryption device further configured to receive operating power from the battery.

16. The voice encryption device of claim 1, further comprising a microphone configured to generate the sequence of voice data responsive to detection of an audible voice.

17. The voice encryption device of claim 1, further comprising a battery, a coil and a charger,
the battery configured to store operating power for the voice encryption device,
the coil configured to generate an induced current responsive to an externally generated electromagnetic field, and
the charger configured to charge the battery using the induced current.

18. The voice encryption device of claim 1, further comprising a battery, a port and a charger,
the port configured to be detachably connectable to an external power source, and
the charger configured to charge the battery using power from the external power source as provided through the port.

19. The voice encryption device of claim 1, further comprising an accelerometer configured to activate the voice encryption device responsive to predefined user initiated movement of the voice encryption device.

20. A voice encryption device comprising:
a pseudorandom number generator configured to generate a key data stream responsive to a cryptographic key;
a shift register configured to sequentially store a sequence of voice data as a block of voice data;
a selector configured to select pieces of voice data from among the block of voice data stored by the shift register and provide a rearranged block of voice data including the selected pieces of voice data as initial pieces of voice data in the rearranged block of voice data responsive to a key data value from among the key data stream; and
a combiner configured to combine the rearranged block of voice data provided from the selector with a previous block of voice data received prior to the block of voice data to generate an encrypted block of voice data.

21-29. (canceled)
